(19) United States
(12) Patent Application Publication
(10) Pub. No.: US 2017/0186113 A1
(43) Pub. Date: Jun. 29, 2017

(54) METHOD, COMPUTER-READABLE STORAGE DEVICE AND APPARATUS FOR PROCESSING A MULTI-FACTOR REQUEST

(71) Applicant: AT&T Intellectual Property I, L.P., Atlanta, GA (US)

(72) Inventors: Venson Shaw, Kirkland, WA (US); Jin He, Fremont, CA (US)

(21) Appl. No.: 14/981,644

(22) Filed: Dec. 28, 2015

(51) Int. Cl. G06Q 50/14; G06Q 30/06; G06Q 50/00; G06Q 10/02

(52) U.S. Cl. CPC G06Q 50/14; G06Q 10/02; G06Q 30/0627; G06Q 50/01

(57) ABSTRACT

Methods, computer-readable storage media and apparatuses for processing a multi-factor request are disclosed. A processor receives, over a communication network, a request for a service having a plurality of factors, wherein a satisfaction rating is provided for each of the plurality of factors by a user, searches for a service that attempts to meet the satisfaction rating for each of the plurality of factors, provides a reservation that meets the satisfaction rating for a subset of the plurality of factors, updates dynamically, over the communication network, the reservation to meet the satisfaction rating for another factor that was not part of the subset of the plurality of factors, and presents a rebate or a charge in response to the updating of the reservation.

The present disclosure relates generally to communication networks and, more particularly, to methods, computer-readable storage devices and apparatuses for processing a multi-factor request from a user.

### BACKGROUND

Services today have many service factors or criteria that must be met to meet the satisfaction of a consumer. For example, a cruise ship operator will provide many services to consumers who book a voyage on the cruise ship. For example, a consumer in purchasing a cruise package may receive a plurality of services such as transportation services, lodging services, food services, entertainments services and so on. However, each of the provided services may have only a finite number of availabilities. For example, a cruise ship has a finite number of rooms with balconies, a finite number of dinner reservations for a restaurant on the cruise ship, a limited number of excursions for a port of call, and so on. As such, some consumers who booked a cruise package will likely be unhappy with some aspects of their reservations due to the limited resources.

### SUMMARY

In one example, the present disclosure discloses methods, computer-readable storage media and apparatuses for processing a multi-factor request. For example, a processor receives, over a communication network, a request for a service having a plurality of factors, wherein a satisfaction rating is provided for each of the plurality of factors by a user, searches for a service that attempts to meet the satisfaction rating for each of the plurality of factors, provides a reservation that meets the satisfaction rating for a subset of the plurality of factors, updates dynamically, over the communication network, the reservation to meet the satisfaction rating for another factor that was not part of the subset of the plurality of factors, and presents a rebate or a charge in response to the updating of the reservation.

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates an example user interface for assisting a user to submit a multi-factor request to a service provider;

FIG. 3 illustrates a flowchart of an example method for submitting a multi-factor request by a user in accordance with the present disclosure;

FIG. 4 illustrates a flowchart of an example method for processing a multi-factor request from a user in accordance with the present disclosure; and

FIG. 5 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for processing a multi-factor request from a user. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one example, the present disclosure provides a searching or reservation service that identifies a service sought after by a user. More specifically, the searching or reservation service attempts to match the criteria (e.g., service factors) submitted along with the service request. In one example, the user will associate a satisfaction rating (e.g., a satisfaction score or a satisfaction measure) with each of the criteria that will meet the user's satisfaction.

As discussed above, a cruise ship operator will provide many services to consumers who may book a voyage on the cruise ship. For example, the plurality of services may comprise transportation services, lodging services, food services, entertainment services, child care services, and special access services and so on. Finally, the user will have to pay a cost to book the voyage on the cruise ship. However, each of the provided services may have only a finite number of availabilities. As such, some consumers will not be totally satisfied with their reservations. Similarly, some consumers may be so dissatisfied given the current availability of some desired services that are not available, they may not even make a reservation, thereby causing a missed opportunity of commerce to the operator of the cruise ship.

Furthermore, in making a reservation, a user may simply select one of the remaining available options without truly revealing the user's satisfaction with the selected choice. For example, a user selecting a flight with an airline may select a window seat in the reservation. However, it is unclear as to whether the user is truly satisfied with the window seat, or is simply selecting the window seat given the level of available seats at that given moment in time when the reservation was made.

In other words, a user may provide just enough user preference to satisfy the innate function of a requested service. For example, it is often the case that consumers are requested to provide certain personal information to allow companies, e.g., service providers, to utilize certain amount of their personal data in order to provide one or more innate functionalities. For example, a cellular service provider may request that a consumer consents to have his or her physical location information or data (broadly geo-location information) be used to provide the innate functionality of receiving cellular service. In other words, the cellular service provider must be able to determine the consumer's physical location in order to forward cellular calls to the consumer. Similarly, a mortgage company or a banking institution may request that a consumer consents to have his or her financial information or data be used and verified to receive the innate functionality of receiving a mortgage or a loan. In yet another example, a medical institution may request that a consumer consents to have his or her medical information or data be used and verified to receive the innate functionality of receiving a proper diagnosis of a potential ailment or disease. In yet another example, a media delivery service provider may request that a consumer consents to have his or her media viewing information or data be used and tracked to receive the innate functionality of receiving a notification of a future program that may be of interest to the consumer. In yet another example, a traffic notification service provider may request that a consumer consents to have his or her current location information or data be used and tracked to receive the innate functionality of receiving up to date traffic conditions on a route that the consumer is currently traveling on.

The above list of examples is only illustrative and not exhaustive. It is noted that consumers are becoming ever more protective of their personal data. For example, consumers are concerned with respect to identity theft and misuse of their personal data. However, as illustrated by the above examples, although consumers are worried as to how their data will be used, consumers are nevertheless willing to provide certain amount of personal information to allow companies to use their personal data under certain scenarios, e.g., to receive product/services deem important to the consumers. In other words, consumers are generally willing to give consent to the use of their personal data to support the innate functionality of a particular subscribed service.

On the flip side, companies are very interested in accessing consumers' data (i.e., big data) to provide better services and/or to promote new business opportunities. For example, business entities are often providing a main service that is supplemented by a plurality of secondary or axillary services. To illustrate, an airline is providing a transportation service that may provide axillary services such as a food service, e.g., food and drink items to be made available on the aircraft, and an entertainment service such as an on-board entertainment service for the duration of the flight. Similarly, a stadium is providing a sports viewing service that may provide axillary services such as a food service, e.g., food and drink items to be made available during a football game, and a souvenir purchase service, e.g., providing items to be purchased during the attendance of the sports event by the user.

However, such business entities are often not privy to the personal information as related to ancillary services. For example, when a user is ordering football tickets, the user is not willing or motivated to provide other personal information such as what the user likes to eat. The reasons as to the user's hesitation to provide such food preference may range from wanting to protect their personal information to not wanting to be bothered with numerous personal questions when ordering football tickets. The end result is that third party business entities will not be able to access such privacy information to improve their services, e.g., their ancillary services.

In addition, even if a third party business entity is able to collect such personal information over a long period of time of interaction with the user, a “new” third party business entity will not be able to have such personal information until the new third party business entity is able to learn such personal information from the user through numerous interactions with the user. For example, airline A (e.g., favored by the user for flying) may know the user's preference as to seating, travel time, and food choices, but airline B (e.g., not favored by the user for flying) may have no such knowledge. As such, when the user books a flight with airline B, airline B will not have the necessary personal information to better serve the user. The user will not likely be motivated to be bothered with having to provide any additional personal information to airline B. As such, airline B will not be able to tailor its services to better serve the user in the hope of generating more business from the user. In this illustrative scenario, both the user and the business entity are not benefiting from the use of user's privacy information which already exists in some form.

More importantly, without truly knowing the user's preferences, there will be many instances where the service provider will not even have the opportunity to provide a service to a user. For example, a user looking for a cabin with a balcony on a cruise ship may simply look elsewhere when a cruise ship only has remaining cabins that are located in the interior of the cruise ship. Said another way, the user will not even bother to inquire with the operator of the cruise ship to inquire as to whether there is a chance that another customer is willing to trade his or her cabin with the user. Although the operator of the cruise ship may have an incentive to inquire on behalf of the user with other customers who have reservations for the same voyage about a possible cabin swap, such inquiries are not very practical and will not scale well with a large number of consumers who may need to be asked. Finally, consumers are generally not willing to be bothered with a constant stream of inquiries as to reservations that they have already made.

In one embodiment of the present disclosure, a searching or reservation service is provided by a service provider, e.g., a merchant who is in business to provide a particular service. For example, the service provider may be a cruise ship operator, an airline operator, a resort operator, a hotel operator, a theater operator, an arena operator, a stadium operator, a restaurant operator, and so on. In another embodiment, the service provider may be an intermediary, e.g., a network service provider that operates a communication network or a social network service provider that operates a social networking website. In other words, the intermediary is actually not providing the requested service, but is simply serving as an intermediary to ensure that the user will have a positive user experience in seeking for the availability of a particular service.

As such, in one example the network service provider may receive and store privacy information from the user, which are then used in analytics to provide information to third party business entities on behalf of the user. The term “privacy information” comprises any personal information provided by the user, e.g., contact information (e.g., home address, work address, email addresses, home phone number, work phone number, mobile phone number and the like), and various personal preferences as related to lodging preferences, transportation preferences, eatery preferences, entertainment preferences, financial preferences, medical preferences, and the like. It should be noted that the above list of privacy information is not exhaustive. Once the privacy information is received and stored by the network service provider, analytics can be performed on behalf of the user to interact with third party business entities.

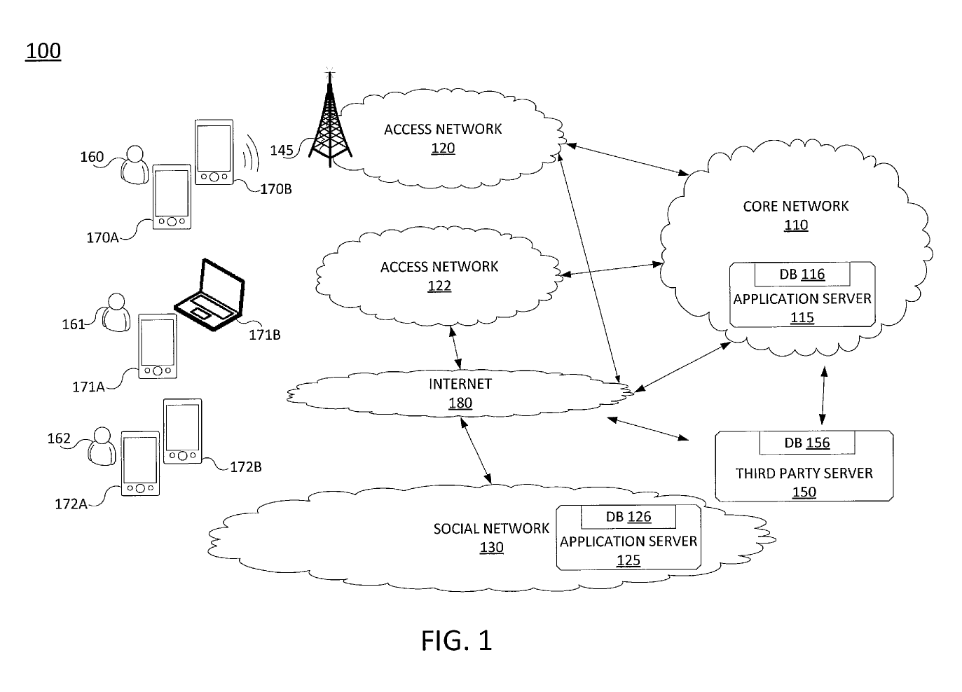

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

As shown in FIG. 1, the communication network 100 connects endpoint devices 170A-172A and 170B-172B with each other and/or with one or more application servers via a core network 110, access networks 120 and 122, social network 130 and/or Internet 180. In one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wireless-Fidelity (Wi-Fi) network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

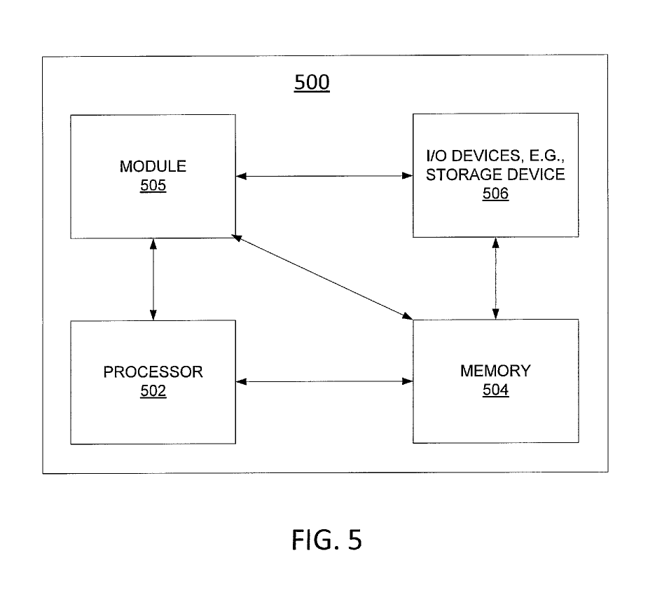

In one embodiment, the core network 110 may include an application server (AS) 115, e.g., a dedicated database server and a database (DB) 116. Although only a single AS 115 and a single DB 116 are illustrated, it should be noted that any number of application servers 115 or databases 116 may be deployed. In one embodiment, the AS 115 may comprise a programmed computing device as illustrated in FIG. 5 and discussed below. In one embodiment, the AS 115 is configured to perform steps, functions and/or operations of a privacy information management service, e.g., for using the stored privacy information to interact with a business entity on behalf of the user, accordance with the present disclosure. As such, DB 116 may store program code, data, files, and so forth to enable such functions. Thus, various embodiments are described herein as residing in or being performed in whole or in part by AS 115. For instance, AS 115 may receive and store the privacy information of a plurality of users (e.g., subscribers of network services from the network service provider of network 102) and use the stored privacy information to process a multi-factor request from a user and to interact with various third party business entities on behalf of the users.

In one example, social network 130 may also include an application server (AS) 125 and a database (DB) 126, which may be the same or similar to AS 115 and DB 116 in the core network 110 and which are also suitable to perform at least the same functions. Similarly, in another embodiment one or more application servers (not shown), e.g., connected to Internet 180, may perform the same or similar functions. In other words, one or more application servers as deployed in a cloud environment may implement the functions as discussed herein.

In one embodiment, each of endpoint devices 170A-172A and 170B-172B may comprise an endpoint device configured for wireless or wired communication such as a personal computer, a laptop computer, a Personal Digital Assistant (PDA), a mobile phone, a smart phone, an email device, a computing tablet, a messaging device, a computing pair of glasses, and the like. As illustrated in FIG. 1, endpoint devices 170A-172A and 170B-172B may belong to and/or be associated with users 160-162, respectively. In particular, each of users 160-162 may have multiple associated endpoint devices. For example, user 160 may have both a personal smart phone (e.g., endpoint device 170A) as well as a work smart phone assigned by an employer (e.g., endpoint device 170B). Similarly, user 161 may have both a mobile phone (e.g., endpoint device 171A) as well as a personal computer (e.g., endpoint device 170B). In addition, user 162 may also have a personal smart phone (e.g., endpoint device 172A) as well as a work smart phone assigned by an employer (e.g., endpoint device 172B).

Notably, one or more of the users 160-162 may be a subscriber of access network 120 and/or core network 110. In other words, the user is already a customer of the network service provider that provides one or more communication services such as cellular phone services, voice over IP services, long distance telephony services, Internet access services, data services, multimedia delivery services, and the like.

Accordingly, in one embodiment DB 116 of AS 115 in the core network 110 may store privacy information of one or more of users 160-162, e.g., users who are also network subscribers. Taking user 160 as an example, the privacy information stored in DB 116 may include a name, billing address, service address, telephone number and email address associated with user 160. The privacy information may also include geographic location information regarding user 160. For example, location information may be determined from a source IP address associated with communications from user 160, global positioning system (GPS) information of a mobile device of the user, serving base station information, and so forth. The privacy information stored in DB 116 may also comprise biographic information, e.g., age, memberships in various groups, professional associations, and so forth, as well as calendar information for the user 160. The privacy information may also include a contact list of the user 160 that may comprise various contacts in various categories including: friends, family, colleagues, sports team members, hobby group members, and so forth. Finally, the privacy information may also include consent information or data associated with how the privacy information can be used in analytics in response to third party business inquiries.

Application server (AS) 115 may also access and/or store in DB 116 call detail records (CDRs) derived from telephone calls, emails, text messages, instant messages, multimedia messages (MMS), VoIP application usage, and the like which traverse various networks including core network 110, access networks 120 and 122, and so forth. Such CDRs may be gathered and accessed using any techniques which are known in the art and may be used for various purposes in accordance with the present disclosure, as described in greater detail below. Furthermore, AS 115 may also have access to various other services that the user may have subscribed to. For example, the user may also have one or more subscriptions to a multimedia content delivery service, e.g., requesting movies to be streamed to the user, an Internet access service, a data delivery service, a health wellness monitoring service, a financial planning service, a banking service, an online product purchase service, a home monitoring service, a home or business security service, a remote network access service and so on. It should be noted that the above list of subscribed services is only illustrative, but is not intended to be exhaustive.

In turn, Application server (AS) 115 may also access and/or store in DB 116 the consents as to the use of the user's privacy information in any one of the subscribed services. In other words, Application server (AS) 115 may serve as a centralized platform for storing the consents as to the use of the user's privacy information. This allows the Application server (AS) 115 to perform analytics on the user's privacy information as part of a privacy information management service provided to the user as further discussed below. Furthermore, Application server (AS) 115 may also enhance the user's experience in terms of processing a multi-factor request from the user as discussed below.

In addition, each of the users 160-162 may participate in social networking via social network 130. Thus, each of the users 160-162 may have a social network privacy information that includes: posts and messages of the user, biographic information of the user, information on contacts of the user and/or other participants of the social network with whom the user has interacted, location/check-in information of the user, and so forth. In one example, the social network privacy information of each of the users 160-162 may be stored in database (DB) 126 of application server (AS) 125. Collectively, the information stored in DB 126 may be referred to as social network information and may be used for supplementing the privacy information as stored by AS 115 in DB 116.

For instance, application server (AS) 115 may access the social network information from AS 125/DB126 and use such information as an alternative to or in conjunction with stored privacy information in DB 116 and call detail record information available to AS 115 to automatically process a multi-factor request from a user and to interact with third party business entities on behalf of the user. For example, the user may have certain subscription to services that are provided or identified via the social network, which may further have associated privacy information of the user. Such privacy information of the user can be extracted from the social network by AS 115 and stored in the DB 116 if consent is provided by the subscriber to perform such extraction, thereby saving user time in having to provide privacy information again to AS 115.

Alternatively, in one example privacy information of the user can be extracted from the core network by AS 125 and stored in the DB 126. In other words, the functions or operations of the present disclosure can be deployed in the AS 125 of the social network as well.

FIG. 1 also shows a third party server 150 with a DB 156, which may be operated by a third party business entity (broadly a business entity), e.g., a vacation resort, a hotel, a motel, a bed and breakfast establishment, a cruise ship operator, an airline, a bus carrier company such as Greyhound Lines™, a train carrier company such as Amtrak®, a restaurant, a bakery, a deli, a theater, a sports team, a sports ticket outlet, a health club, a medical service provider, a hospital, a bank, a mortgage company, a retailer or vendor for providing a product to the user, e.g., a department store, a supermarket, an online retailer and so on. It should be noted that although only one third party server 150 is shown in FIG. 1 for clarity reasons, any number of third party servers can be represented in FIG. 1.

Furthermore, it should be noted that the network 100 has been simplified. For example, the network 100 may include other network elements (not shown) such as border elements, routers, switches, policy servers, security devices, gateways, a content distribution network (CDN), firewalls, and the like. Thus, FIG. 1 is only intended to illustrate one example environment in which embodiments of the present disclosure may be employed.

In one embodiment, the user provides privacy information to the communication network operated by the network service provider to be managed via a privacy information management service. Privacy information may comprise: 1) geo-location information, e.g., the current physical location of the user, 2) multimedia content consumption information, e.g., the type of content such as movies and/or programs watched and preferred by the user, 3) viewing schedule information, e.g., time schedule that the user is watching or prefers to watch the content, e.g., 9:00 pm on a Sunday and so on, 4) medication information, e.g., medication purchased by the user, 5) medical information, e.g., medical conditions associated with the user, medical services used by the user, e.g., hospitals and medical clinics, 6) delivery of product information, e.g., the time and day that a product is delivered to the user, 7) financial information, e.g., banking information, mortgage information, credit information, credit card information and the like, 8) biometric information, e.g., the current body temperature of the user, the current weight of the user, the current shoe size of the user, the current height of the user, and the like, 9) appointment information of the user, e.g., events on a calendar of the user, 10) communication information, e.g., individuals that the user has communicated with via phone calls, emails, text messages, the preferred modality of communication, e.g., texting, emails, cellular calls, and the like, 11) contact information, e.g., phone numbers of contacts (e.g., friends, family and co-workers), email addresses of contacts, home addresses of contacts, 12) lodging preferences (e.g., types of hotels, brand of hotel chains, types of rooms, smoking or non-smoking rooms, and so on), 13) traveling preferences (e.g., types of transportation mode (e.g., planes, trains, buses, or types of rental cars), brand of airlines, bus carriers, train carriers, types of seating, types of travel locations, types of landmarks to be visited when travelling, and so on), 14) eatery preferences (e.g., types of restaurants, types of food, types of spices to be applied to food, range of costs willing to be incurred for food and drink, locations of eateries), 15) entertainment preferences (e.g., types of sports, types of shows, types of movies, types of television programming, types of music), and so on. Again, this list of privacy information is only illustrative and should not be deemed to be an exhaustive list.

Given the need of the innate functionality of a user procuring various services and making various product purchases, a user may have to provide certain portions of the privacy information to be used by one or more business entities. Thus, each of many business entities may have obtained a very small subset of the privacy information for a user by interacting with the user via one or more business transactions, but no single business entity would likely have the entire set of privacy information for each user.

For example, purchasing a product online may require the user to provide consent as to the use of: 1) the user's credit card information to complete the transaction, and 2) the user's email address to receive product delivery tracking information, e.g., a tracking number of a delivery service. In another example, purchasing a medical boot may require the user to provide consent as to the use of: 1) the user's medical records to ascertain the prescription for the purchase of the medical boot, and 2) the user's biometric information such as the size of the user's foot so that a properly sized medical boot can be determined. Such consents are often freely provided by the users since they pertain to the innate functionalities of the provided services.

However, the privacy information provided in the above examples can be leveraged to provide a searching or reservation service to the user. For example, the user's email address can be used to receive a confirmation of a purchase, to receive a notification that a product has been shipped, to receive a notification that a product is back ordered, to receive a notification that a flight has been canceled due to weather, to receive a notification that a Broadway show has been canceled, to receive a notification that a flight upgrade is available, and so on. In another example, the user's lodging preference can be used to receive a notification that a room upgrade is available. In another example, the user's entertainment preference can be used to receive a notification that a ticket is available for a particular sports event. However, business entities without access to such privacy information will not be able to ascertain the numerous different preferences of a very large number of users. In turn, the business entities will likely bombard all users with various business opportunities. In turn, users are fatigue from receiving so many unfocused solicitations such that many users may setup filters to block out such unwanted solicitations. However, not all solicitations are unwanted by the users. The users may simply be inundated with so many solicitations on such a regular basis that users are no longer interested in reading all of the solicitations. As a result, the business entities are not getting the benefit of their marketing efforts and the users are not getting the benefit of having their preferences addressed and met.

In one embodiment, the present disclosure provides a searching and reservation service that processes a multi-factor request from a user. In processing the user's multi-factor request, privacy information stored on a communication network of the network service provider can be optionally leveraged. However, it should be noted that using the privacy information stored on a communication network of the network service provider is not a requirement of the present disclosure.

For example, the privacy information can be manually provided to the network service provider, e.g., answering a survey with a plurality of questions. In another example, the privacy information can be automatically extracted by the network service provider, e.g., monitoring the user's commercial transaction activities (e.g., commercial transactions in procuring goods or services) over the communication network, monitoring the user's communication activities (e.g., email communications, text messaging activities, phone records, and the like), and so on. In other words, if the network service provider is providing Internet access service to the user, then the network service provider may monitor the transactions made by the user over the Internet. Similarly, if the network service provider is providing cellular service or data service to the user, then the network service provider may monitor the communication activities and transactions made by the user over the cellular service or data service. Any such automatic monitoring must be in accordance with receiving an affirmative consent by the user as part of the privacy information management service. This allows the user to consolidate his or her privacy information in one centralized platform. In one example, the network service provider is then tasked with performing analytics on the privacy information to process a multi-factor request from a user.

For example, a user has reserved a voyage with a cruise ship operator. The reservation indicates a 10-day cruise with: 1) airline flights to and from the port of departure (e.g., economy seats), 2) an interior cabin, 3) two nights of dinner reservations for premium dining restaurants on the cruise ship, 4) one excursion at a port of call, 5) child care service for one evening, 6) a special access to a premium lounge between 8:00-10:00 am to meet animated characters, e.g., for a meet and greet session with opportunity for receiving autographs from the animated characters, and 7) for a cost of $10,000. However, analyzing the reservation in and of itself may prove difficult to ascertain whether the user is truly satisfied with the reservation. For example, the user may have truly wanted: 1) a cabin with a balcony instead of an interior cabin, 2) five nights of dinner reservations for premium dining restaurants on the cruise ship instead of two nights, and 3) child care service for five evenings instead of one evening. Furthermore, the user truly does not care about the excursion and the special access and would have been quite happy to pay up to $13,000 to have his or her preferences met.

In contrast, there may be another user who has the exact opposite preferences. For example, the reservation of the other user may comprise: 1) airline flights to and from the port of departure (e.g., economy seats), 2) a cabin with a balcony, 3) six nights of dinner reservations for premium dining restaurants on the cruise ship, 4) no excursion at a port of call, 5) child care service for nine evenings, 6) no special access to the premium lounge, and 7) for a cost of $15,000. The other user may have truly wanted: 1) the excursion at the port of call and 2) the special access. Furthermore, the user truly does not care about the six nights of dinner reservations for premium dining restaurants on the cruise ship and the cabin with a balcony and would have been quite happy to reduce his or her cost by $5,000 to have an interior cabin and to have more excursions during the port of calls.

As the above examples illustrate, the true satisfaction levels of the various consumers for a particular service offered by a business entity is often very difficult to ascertain. Furthermore, even if such true satisfaction levels can be determined, there is no mechanism to dynamically address the concerns and/or desires of numerous users.

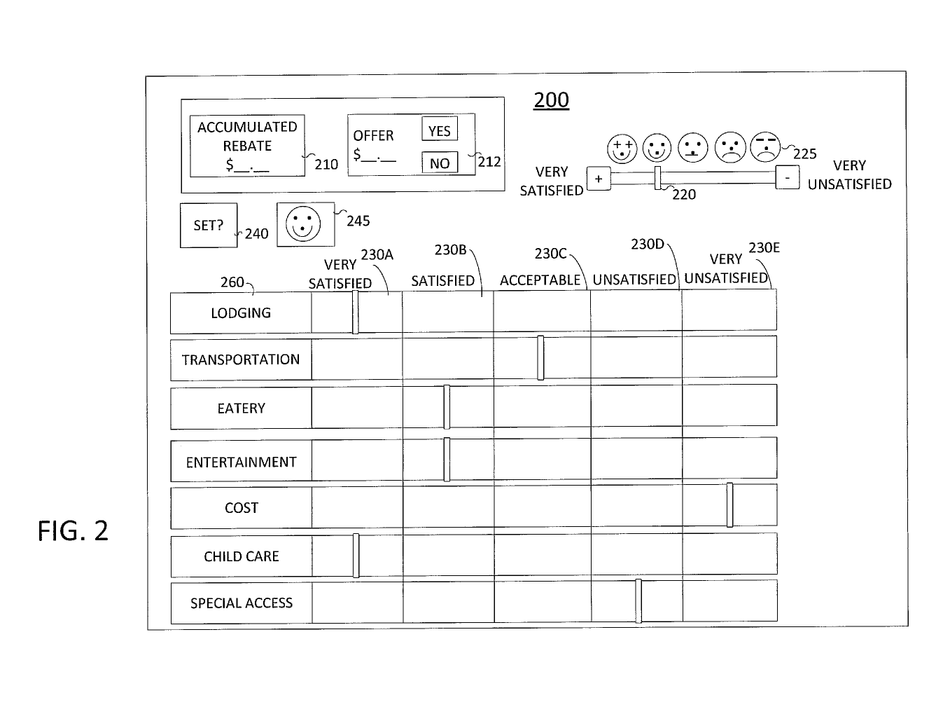

FIG. 2 illustrates an example user interface or screen 200 showing user's preferences as to a multi-factor request for a service, e.g., a request for a cruise package. In other words, booking a reservation for a voyage on a cruise ship necessitates the consideration of a plurality of factors or criteria. Meeting these factors or criteria to the satisfaction of a user will be instrumental in consummating the transaction. Said another way, each user may hold a subset of factors to be non-negotiable, whereas another subset of other factors are negotiable. By meeting at minimum, the subset of factors deemed to be non-negotiable to the satisfaction of the user will likely bring about a positive experience to the user and will likely increase the revenue generation capability of a business entity.

Returning to FIG. 2, in one example, the plurality of factors or criteria 260 of a multi-factor request for a service (e.g., a cruise ship voyage) may comprise: a lodging factor, a transportation factor, a food (eatery) factor, an entertainment factor, a cost factor, a child care factor, and/or a special access factor and so on. For example, the lodging factor may have a plurality of components: 1) a smoking versus a non-smoking room, 2) a type of bed in the room, e.g., a king bed, a queen bed, or a twin bed, 3) a type of view of the room, e.g., an ocean view, a city view, a garden view, an interior view, and so on, 4) a type of room, e.g., a regular room, a suite with a kitchen and a living room, a penthouse having multiple floors, or a room with a balcony, 5) a cost of the room, and so on. For example, the transportation factor may have a plurality of components: 1) a class of travel (e.g., first class, business class, premium class, or economy class, 2) a type of seating (e.g., a window seat, an aisle seat, or a middle seat), 3) a cost of the transportation, 4) a type of transportation vehicles, ships or planes, and so on. For example, the food factor may have a plurality of components: 1) a type of restaurants, 2) an availability of having a reservation, 3) an availability of types of meals (e.g., breakfast, lunch, dinner, snack, vegetarian menu items, gluten free menu items, and the like), 4) a cost of the meals, and 5) hours of operation. For example, the entertainment factor may have a plurality of components: 1) a type of entertainment (e.g., Broadway style shows, movies, excursions, sports viewing events, sports participation events, food and wine tasting events, and so on), 2) a frequency of participating in certain entertainment activities, 3) a cost of each entertainment activity, 4) a location of each entertainment activity, and so on. For example, the cost factor may have a plurality of components: 1) a cost in terms of dollar value, 2) a method of payment, 3) a timeline in which the payment is due, and so on. For example, the child care factor may have a plurality of components: 1) the age of the child to be cared for, 2) a gender of the child to be cared for, 3) a frequency of the child care service, 4) a ratio of child care provider versus a number of children to be cared for, 5) hours of operation, and so on. For example, the special access factor may have a plurality of components: 1) the time of the special access, 2) the location of the special access, 3) a type of event associated with the special access, 4) the frequency of the special access, 5) the cost of the special access, and so on. It should be noted that the above list of factors and their respect components are only illustrative and should not be deemed as a limitation of the present disclosure.

In one example, the interface 200 allows each of the factors on the list to be associated with a satisfaction rating, e.g., very satisfied, satisfied, acceptable, unsatisfied, and very unsatisfied. Broadly, the “satisfaction rating” is a measurement (e.g., like a score) of how important each factor is to the user in terms of meeting the satisfaction of the user for a particular factor. In one illustrative example, the satisfaction rating is as follows: “very satisfied” means that all components relating to that factor must be met as specified by the user, “satisfied” means that at least 75% of the components relating to that factor are met as specified by the user, “acceptable” means that at least 50% of the components relating to that factor are met as specified by the user, “unsatisfied” means that at least 25% of the components relating to that factor are met as specified by the user, and “very unsatisfied” means that less than 25% of the components relating to that factor are met as specified by the user. The chosen percentages associated with the various satisfaction ratings can be selected in accordance with the requirements of a particular implementation and the above example should not be interpreted as a limitation of the present disclosure. Furthermore, the various satisfaction ratings can be expressed in other formats, e.g., with a numeric 1-5 scale or a numeric 1-10 scale, with a binary scale (e.g., “satisfied” or “unsatisfied”), and so on.

By providing the satisfaction rating for each factor or criterion of a multi-factor request for a service to be received by a service provider that is tasked with finding a requested service that will meet the satisfaction of the user, it will produce more accurate search results and ultimately provide a better user experience. In other words, the user is providing additional privacy information to the service provider to enable the service provider to seek out a service that will best match the satisfaction of the user. One aspect of providing the satisfaction rating for each factor or criterion of a multi-factor request to the service provider is that the service provider will now be able to properly ascertain what factors are negotiable (e.g., deemed not as important to the user) and what factors are non-negotiable (e.g., deemed to be very important to the user). In fact, the degree of negotiability is also known. Such access to this type of privacy information of the user will allow the service provider to locate and present a better match to the user. More specifically, if the service provider is able to obtain this information from a plurality of users, e.g., 1,000 users, who are seeking to reserve a plurality of available services, e.g., 1,000 cabins in a cruise ship, then the cruise ship operator will be in a better position to offer certain combinations of services that will meet as many of the users as possible, thereby producing a very high level of satisfactions for as many of the plurality of users as possible. Said another way, the service provider will be able to implement one or more “give and take” methods that will attempt to address the most important factors of all of the users first and then subsequently address the allocation of any remaining services in a manner that will create the greatest level of satisfaction for as many users as possible. The users benefit from having a positive user experience and the service provider will benefit from increasing the level of commerce, e.g., selling more cabins on the cruise ship that are otherwise not reserved.

It should be noted that components for each of the factors as discussed above are not shown in FIG. 2. However, the components of each factor can be presented on a second interface screen, e.g., when the pertinent factor is accessed (e.g., clicked). Using FIG. 2 as an example only, the user has indicated that the factors: 1) lodging and 2) child care are factors that will create a high level of satisfaction if the factors' components are met completely, whereas the factors: 3) eatery and 4) entertainment are factors that will still create a high level of satisfaction even if 75% of the factors' components are met, whereas the transportation factor is a factor that will still create a high level of satisfaction even if only 50% of the factor's components are met, whereas the special access factor is a factor that will still create a high level of satisfaction even if only 25% of the factor's components are met, and whereas the cost factor is a factor that will still create a high level of satisfaction even if less than 25% of the factor's components are met. A simplified summary of the user of FIG. 2 is that the user is quite adamant that his or her request for lodging service and child care service must be met completely in order for the user to be satisfied, whereas the user will likely still be satisfied if the user's request for eatery and entertainment services are mostly met, whereas the user will likely still be satisfied if the user's request for transportation services are generally met, and finally whereas the user is ambivalent as to the factors of special access and the cost of the voyage. Again, this is only a very simplified view of the user's overall preference in booking a cruise. Armed with this type of privacy information, the cruise operator (or the network service provider in one example) will be able to better meet the constraints outlined by this user in view of constraints outlined by other users who are also looking to book a cruise.

In one embodiment, a sliding bar 220 can be used by the user to broadly select a satisfaction rating via a global tap for all of the factors 260 instead of selecting a satisfaction rating for each individual factor. A plurality of icons, e.g., emoji, can be used to illustrate the various satisfaction rating options to the user.

In one embodiment, the user's multi-factor request for a service can be implemented as a dynamic process. For example, once the multi-factor request is submitted, the user is accorded a particular reservation with certain factors initially set and reserved for the user. However, the user's reservation with these initially preset factors and reserved for the user can be dynamically changed based on offer(s) presented by the service provider. For example, an offer 212 may dynamically be presented to the user on interface 200. The offer may be a request to swap a dinner reservation for a particular premium restaurant on the cruise ship to a different time. In one example, the offer is accompanied by a dollar value should the user decides to accept the offer, e.g., “Are you willing to move your dinner appointment for restaurant X scheduled for 6:00 pm to 8:00 pm in exchange for a $50 rebate?” If the user accepts the offer, a field 210 will illustrate the current amount of accumulated rebate or credit accorded to the user. The accumulated rebate or credit can be applied to the total cost of the cruise package. It should be noted that the accumulated rebate or credit could be a negative amount. For example, a user will now be able to present an offer in exchange for paying a premium if the service provider is able to locate another user willing to take the user's offer, e.g., “I am willing to pay $50 if I can swap my 8:00 pm dinner reservation to 6:00 pm instead.” Responsive to the user's offer, the service provider may now present such an offer to all users who have a dinner reservation at 6:00 pm at restaurant X with the $50 rebate. If a user is willing to accept the offer, then two users have benefited from this exchange and their user experiences have been enhanced. This illustrative example can be extended to any components of any factors, e.g., “I am willing to pay $3,000 for an upgrade to a cabin with a balcony,” “I am willing to pay $100 to have a time slot in the morning to meet an animated character,” “I am willing to pay $200 to have two tickets for the sold out show X,” and so on. In other words, the user's initial reservation can be dynamically updated with additional offers being presented.

In one example, the interface or screen 200 may have a field 240 in which a user may permanently “set” his or her reservation. In other words, the user may be unwilling to entertain any further changes and does not want to receive any more offers. By selecting the set button or field, the service provider will know that the user does not want any more offers and that the user's reservation is now permanently set.

In one example, an icon 245, e.g., an emoji, may illustrate the overall satisfaction level of the user's reservation. In other words, as the components of various factors are dynamically met, the icon 245 may reflect the overall satisfaction of the user relating to this particular reservation. The user may allow the icon (or the information represented by the icon) to be automatically sent back to the service provider as a feedback when the user's reservation is set or after the voyage is taken. This allows the service provider to receive useful user feedback as to the service provider's ability to meet the overall satisfaction of the user.

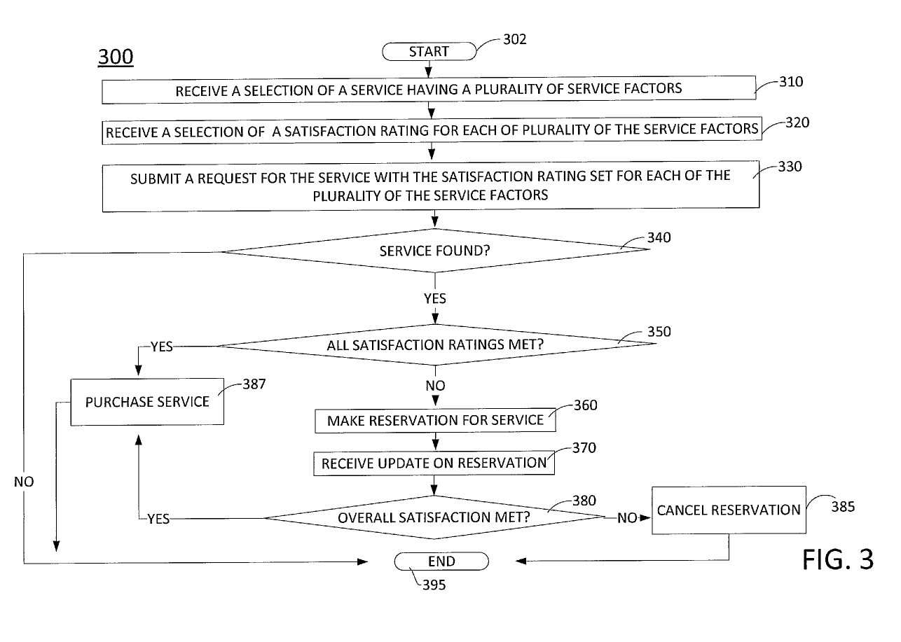

FIG. 3 illustrates a flowchart of an example method 300 for submitting a multi-factor request by a user in accordance with the present disclosure. In one embodiment, steps, functions and/or operations of the method 300 may be performed by a user endpoint device, e.g., endpoint device 170A or 170B in FIG. 1, or by a network-based device in conjunction with a user endpoint device. In one embodiment, the steps, functions, or operations of method 300 may be performed by a computing device or system 500, and/or processor 502 as described in connection with FIG. 5 below. For illustrative purpose, the method 300 is described in greater detail below in connection with an embodiment performed by a processor, such as processor 502. The method begins in step 302 and proceeds to step 310.

At step 310, the processor receives a selection of a service having a plurality of service factors. For example, a user inputs a multi-factor request for a service having a plurality of service factors, e.g., searching for a cruise package, searching for a vacation package, searching for a seminar package and so on. Said another way, a multi-factor request for a service is a request that is seeking a service that has a plurality of service factors where each service factor forms a portion of the overall service. Thus, a cruise ship service necessarily must provide at minimum, a transportation service (e.g., the ship is traveling to some destination), a lodging service (e.g., the user must have a room or cabin to stay in) and a food service (e.g., the user is provided with food on the ship). In one example, the request may comprise a cruise voyage to the Bahamas, a stay at a Disney® resort, or a stay in Hawaii to attend a technical conference, and so on.

In step 320, the processor receives a selection of a satisfaction rating for each factor associated with the requested service. For example, the user inputs a satisfaction rating for each factor, e.g., selecting one of: e.g., “very satisfied,” “satisfied,” “acceptable,” “unsatisfied,” and “very unsatisfied” or from a numeric 1-5 scale, and so on.

In step 330, the processor, send the request, e.g., a multi-factor request, for a service to a service provider with the satisfaction rating set for each of the plurality of the service factors to a service provider. In one example, the service provider is a business entity, e.g., a cruise ship operator, a vacation resort operator and the like. Alternatively, in one embodiment the service provider may be a network service provider or a social network service provider, that are then tasked with interacting with other business entities to find a requested service that will satisfy the user's multi-factor request.

At step 340, the processor will determine whether a service is found. For example, method 300 determines whether a service that matched the requested service is found, e.g., is there a Bahama cruise that matches the user's request. If the answer is positive at step 340, the processor will proceed to step 350. If the answer is negative at step 340, the processor will proceed to step 395 where the processor will provide a negative response and method 300 will end.

At step 350, the processor will determine whether all of the satisfaction ratings for all of the factors are met. For example, if the user wants a cabin with a balcony, and such a cabin is available to be reserved by the user, then the satisfaction rating associated with “lodging” is met. In another example, if the user wants a reservation to have dinner for a restaurant on the cruise ship, and such reservation is not available, then the satisfaction rating associated with “eatery” may not be met. However, since the degree of meeting the satisfaction of the user may be analyzed based on the selected satisfaction rating itself, there may still be an opportunity that the user's overall satisfaction is met based on whether the user is enamored with this particular factor of the requested service. If the answer is positive at step 350, the processor will proceed to step 387. If the answer is negative at step 350, the processor will proceed to step 360.

In step 387, the processor will purchase the requested service, e.g., making a payment for a cruise or for a vacation package at a resort. Alternatively, the processor may simply make a reservation for the requested service.

In step 360, the processor will make a reservation for the requested service. For example, even when all of the satisfaction ratings are not met at the moment, the processor may still make a reservation for the requested service. In other words, the fact that not all of the satisfaction ratings are met may not be a deterrent for the user in purchasing the requested service. In other words, the decision may rest on the “overall” degree of satisfaction when all of the factors are accounted for.

In step 370, the processor may receive an update on the reservation, e.g., one or more components of one or more factors may have changed, e.g., a cancellation occurred such that a type of cabin is now available, a new block of cabins may have been released to the general public for reservation, there is a reduction in the cost affecting one of the factors, another user has presented an offer that may interest the user, the service provider itself as provided a new offer or a modified offer, and so on. It should be noted that step 370 is not a single step, but may encompass multiple instances over a period of time in which many changes may occur that will bring about a change or an update to the reservation. For example, a reservation may be made in January with final payment due in June for a cruise to take place in August. Thus, many changes and/or offers may occur between January and June before the final payment is due. In other words, the user may not need to fully commit to the purchase of the service until June.

At step 380, the processor will determine whether the “overall” satisfaction is met. For example, although not all of the factors of the requested service are met, is the user satisfied with those factors that are met. If the answer to the query is positive, method 380 will proceed to step 387, where the service is purchased. If the answer to the query is negative, method 380 will proceed to step 385, where the reservation is canceled. Method 300 ends in step 395.

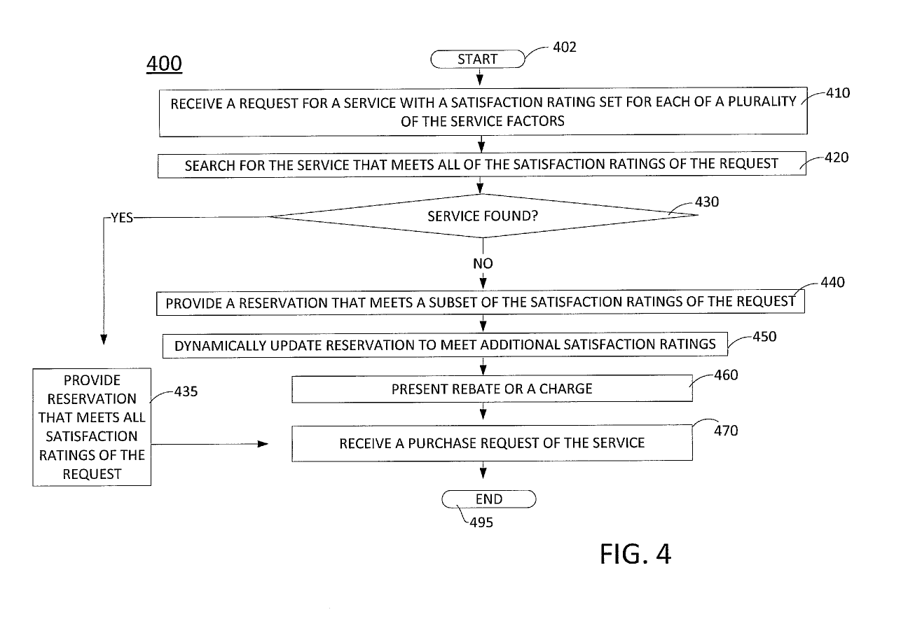

FIG. 4 illustrates a flowchart of an example method 400 for processing a multi-factor request from a user in accordance with the present disclosure. In one embodiment, steps, functions and/or operations of the method 400 may be performed by a network-based device, e.g., application server 115 or application server 125, in FIG. 1. In one embodiment, the steps, functions, or operations of method 400 may be performed by a computing device or system 500, and/or processor 502 as described in connection with FIG. 5 below. For illustrative purpose, the method 400 is described in greater detail below in connection with an embodiment performed by a processor, such as processor 502. The method begins in step 402 and proceeds to step 410.

At step 410, the processor receives a request, e.g., a multi-factor request, for a service with a satisfaction rating set for each of the plurality of the service factors. In one example, the service provider is a business entity, e.g., a cruise ship operator, a vacation resort operator and the like. Alternatively, in one embodiment the service provider may be a network service provider or a social network service provider, that are then tasked with interacting with other business entities to find a requested service that will satisfy the user's multi-factor request.

At step 410, the processor will attempt to search for a service that will meet all of the satisfaction ratings of the request. For example, if the service provider is a business entity, then the business entity will search internally its own database to see whether the request can be fully satisfied. For example, if the business entity is a cruise ship operator, it will see if a cruise package is available to meet the requirements of the request. In another example, if the service provider is a network service provider (or a social network service provider), then the network service provider will interact with a plurality of business entities on behalf of the user to see whether the request can be fully satisfied. For example, if the network service provider is a communication network service provider, it will then interact with a plurality of cruise ship operators to see whether any one of them will have a cruise package that is available to meet the requirements of the request. In one embodiment, the network service provider may use additional privacy information in its search. For example, the network service provider may know that the user is unhappy with ABC cruise ship operator through monitoring of the user's social networking activities, then the search will not include interacting with ABC cruise ship operator to identify an available service.

At step 430, the processor will determine whether a service is found. For example, method 400 determines whether a service that matched the requested service is found, e.g., is there a Bahama cruise that matches the user's request. If the answer is positive at step 430, the processor will proceed to step 435. If the answer is negative at step 430, the processor will proceed to step 440.

At step 435, the processor will provide a reservation and/or a purchase order that meets all of the satisfaction ratings of the request.

At step 440, the processor will provide a reservation and/or a purchase order that meets a subset of the satisfaction ratings of the request. In other words, certain factors of the request will not be met in the reservation or purchase order.

In step 450, the processor may dynamically update the reservation provided in step 440 to meet possibly additional satisfaction ratings. For example, an update to the reservation can be made in response to certain changing conditions, e.g., one or more components of one or more factors may have changed, e.g., a cancellation occurred such that a type of cabin is now available, a new block of cabins may have been released to the general public for reservation, there is a reduction in the cost affecting one of the factors, another user has presented an offer that may interest the user, the service provider itself as provided a new offer or a modified offer, and so on. Said another way, the method updates the reservation to meet the satisfaction rating for another factor that was not previously part of the subset of the plurality of factors that was satisfied. It should be noted that step 450 is not a single step, but may encompass multiple instances over a period of time in which many changes may occur that will bring about a change or an update to the reservation. For example, a reservation may be made in January with final payment due in June for a cruise to take place in August. Thus, many changes and/or offers may occur between January and June before the final payment is due. In other words, the user may continue to receive reservation updates up to the date in which final payment is due.

At step 460, the processor may present a rebate or a charge to the user. For example, the changes to the reservation may result in a monetary benefit that will serve as a credit to the overall cost of the requested service. Alternatively, the changes to the reservation may incur a monetary liability that will serve as a charge to the overall cost of the requested service.

At step 470, the processor receives a purchase request of the service. For example, the purchase of the service can be consummated, e.g., taking of payments from the user and the like. Method 400 ends in step 495.

It should be noted that although not specifically specified, one or more steps, functions or operations of the method 300 and method 400 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIG. 3 and FIG. 4 that recite a determining operation or involve a decision do not necessarily require that both branches of the determining operation be practiced. In other words, one of the branches of the determining operation can be deemed as an optional step. In addition, one or more steps, blocks, functions or operations of the above described method 300 may comprise optional steps, or can be combined, separated, and/or performed in a different order from that described above, without departing from the example embodiments of the present disclosure.

As such, the present disclosure provides at least one advancement in the technical field of processing a multi-factor request. This advancement allows for a dedicated system to receive and utilize satisfaction ratings from a plurality of users so that limited service resources can be properly parsed out in a manner that will maximize the overall satisfaction level of a greatest number of users seeking for a particular service. The present disclosure also provides a transformation of data. For example, privacy information such as satisfaction ratings are transformed into a mechanism to dynamically provide updates to a reservation.

Finally, embodiments of the present disclosure improve the functioning of a computing device, e.g., a server and/or a user endpoint device. Namely, a server or endpoint device dedicated for processing a multi-factor request is improved by increasing the likelihood that a matched service can be located for a user. In one example, the present disclosure is necessarily rooted in the use of a communication network to bring about the dynamic reservation update capability as discussed above.

FIG. 5 depicts a high-level block diagram of a computing device suitable for use in performing the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for providing a privacy information management service, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 or method 400 as discussed above is implemented in a distributed or parallel manner for a particular illustrative example, i.e., the steps of the above method 300 or method 400, or the entire method 300 or method 400 is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300 or method 400. In one embodiment, instructions and data for the present module or process 505 for processing a multi-factor request (e.g., a software program comprising computer-executable instructions) can be loaded into memory 504 and executed by hardware processor element 502 to implement the steps, functions or operations as discussed above in connection with the illustrative method 300 or method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for processing a multi-factor request (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

It should be noted that “configuring” an electrical device may comprise the loading of instructions or machine readable codes onto the electrical device. Said another way, one or more electrical signals can be applied to the electrical device to configure the device to perform one or more described functions. Furthermore, it should be noted that “configuring” an electrical-mechanical device may comprise the loading of instructions or machine readable codes onto the electrical-mechanical device and/or implementing structural features (e.g., of appropriate size, shape and material) to bring about one or more described electrical and/or mechanical functions.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method comprising:
receiving, by a processor of a service provider and over a communication network, a request for a service having a plurality of factors, wherein a satisfaction rating is provided for each of the plurality of factors by a user;
searching, by the processor, for a service that attempts to meet the satisfaction rating for each of the plurality of factors;
providing, by the processor, a reservation that meets the satisfaction rating for a subset of the plurality of factors;
updating dynamically, by the processor and over the communication network, the reservation to meet the satisfaction rating for another factor that was not part of the subset of the plurality of factors; and
presenting, by the processor, a rebate or a charge in response to the updating of the reservation.

2. The method of claim 1, wherein the service provider is a business entity in business to provide the service.

3. The method of claim 1, wherein the service provider is a social network service provider operating a social networking website.

4. The method of claim 1, wherein the service provider is a network service provider operating the communication network.

5. The method of claim 4, wherein the searching is performed using privacy information that is received from the user.

6. The method of claim 4, wherein the searching is performed using privacy information that is extracted from a user profile obtained from a social network.

7. The method of claim 1, further comprising:
receiving, by the processor, a purchase request of the service.

8. The method of claim 1, wherein the service relates to a vacation package.

9. A non-transitory computer-readable storage medium storing instructions which, when executed by a processor of a service provider, cause the processor to perform operations, the operations comprising:
receiving, over a communication network, a request for a service having a plurality of factors, wherein a satisfaction rating is provided for each of the plurality of factors by a user;
searching for a service that attempts to meet the satisfaction rating for each of the plurality of factors;
providing a reservation that meets the satisfaction rating for a subset of the plurality of factors;
updating dynamically, over the communication network, the reservation to meet the satisfaction rating for another factor that was not part of the subset of the plurality of factors; and
presenting a rebate or a charge in response to the updating of the reservation.

10. The non-transitory computer-readable storage medium of claim 9, wherein the service provider is a business entity in business to provide the service.

11. The non-transitory computer-readable storage medium of claim 9, wherein the service provider is a social network service provider operating a social networking website.

12. The non-transitory computer-readable storage medium of claim 9, wherein the service provider is a network service provider operating the communication network.

13. The non-transitory computer-readable storage medium of claim 12, wherein the searching is performed using privacy information that is received from the user.

14. The non-transitory computer-readable storage medium of claim 12, wherein the searching is performed using privacy information that is extracted from a user profile obtained from a social network.

15. The non-transitory computer-readable storage medium of claim 9, further comprising:
receiving a purchase request of the service.

16. The non-transitory computer-readable storage medium of claim 9, wherein the service relates to a vacation package.

17. A device comprising:
a processor of a service provider; and
a computer-readable medium storing instructions which, when executed by the processor, cause the processor to perform operations, the operations comprising:
receiving, over a communication network, a request for a service having a plurality of factors, wherein a satisfaction rating is provided for each of the plurality of factors by a user;
searching for a service that attempts to meet the satisfaction rating for each of the plurality of factors;
providing a reservation that meets the satisfaction rating for a subset of the plurality of factors;
updating dynamically, over the communication network, the reservation to meet the satisfaction rating for another factor that was not part of the subset of the plurality of factors; and
presenting a rebate or a charge in response to the updating of the reservation.

18. The device of claim 17, wherein the service provider is a business entity in business to provide the service.

19. The device of claim 17, wherein the service provider is a social network service provider operating a social networking website, or a network service provider operating the communication network.

20. The device of claim 19, wherein the searching is performed using privacy information that is received from the user or that is extracted from a user profile obtained from a social network.
